(19) United States
(12) Patent Application Publication
(10) Pub. No.: US 2018/0032418 A1
(43) Pub. Date: Feb. 1, 2018

(54) Application-Specific, Performance-Aware Energy Optimization

(71) Applicant: Futurewei Technologies, Inc., Plano, TX (US)

(72) Inventors: Jun Wang, Santa Clara, CA (US); Karthik Rao, Santa Clara, CA (US); Handong Ye, Santa Clara, CA (US)

(21) Appl. No.: 15/224,834

(22) Filed: Aug. 1, 2016

(51) Int. Cl. G06F 11/30; G06F 11/32; G06F 1/32; G06F 9/50; G06F 9/30

(52) U.S. Cl. CPC G06F 11/3051; G06F 9/5016; G06F 9/3009; G06F 1/3206; G06F 11/302; G06F 11/3024; G06F 11/3027; G06F 11/3037; G06F 11/328; G06F 3/04842

(57) ABSTRACT

An apparatus comprises: a non-transitory memory comprising an application; a controller coupled to the memory and configured to adjust a configuration associated with the application independently of other applications in the apparatus, wherein the configuration is an assignment of resources of the apparatus; and a profiler coupled to the memory and configured to: measure a measured performance corresponding to the configuration; and measure a measured power consumption corresponding to the configuration. A method comprises: determining a performance associated with an application; executing a configuration associated with the application in order to substantially maintain the performance while reducing an energy consumption associated with the application; measuring a measured performance resulting from the executing; and adjusting the configuration in response to the measured performance.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Mobile phones, laptop computers, tablet computers, and other smart devices are proliferating. Applications for those smart devices are likewise proliferating. Smart device manufacturers must increase processing power in order to accommodate the increased processing demand from the applications. However, increased processing power requires increased electrical power, and increased electrical power causes increased battery consumption. In order to address the increased battery consumption, the smart device manufacturers seek to increase battery life and seek to improve electrical power management by decreasing power consumption so that smart phone users maintain extended battery lives.

### SUMMARY

Current power management techniques are application agnostic. For that reason, those techniques do not provide optimal power management for many applications. According to various embodiments of the present disclosure, application-specific, performance-aware energy optimization is provided. A controller executes configurations in an application-specific manner. In other words, the controller executes the configurations for an application independently of other applications. In this context, independently may mean that the controller executes the configurations while the application is running and regardless of whether or not other applications are running. The controller executes the configurations in a performance-aware manner. For instance, the controller may distinguish between critical applications and non-critical applications, maintain or substantially maintain default performances for critical applications, and maintain or substantially maintain performances for non-critical applications. The embodiments substantially maintain performances of the applications while reducing energy consumptions of the applications. Energy is equal to power multiplied by time, so reducing power consumptions reduces energy consumptions when a time duration is fixed. Reducing the energy consumptions extends a battery life.

In one embodiment, an apparatus comprises: a non-transitory memory comprising an application; a controller coupled to the memory and configured to adjust a configuration associated with the application independently of other applications in the apparatus, wherein the configuration is an assignment of resources of the apparatus; and a profiler coupled to the memory and configured to: measure a measured performance corresponding to the configuration; and measure a measured power consumption corresponding to the configuration. In some embodiments, the configuration comprises one of a processor frequency associated with the application, a memory bandwidth associated with the application, a thread migration associated with the application, a GPU frequency associated with the application, or a network packet rate associated with the application; the configuration comprises at least two of a processor frequency associated with the application, a memory bandwidth associated with the application, a thread migration associated with the application, a GPU frequency associated with the application, or a network packet rate associated with the application; the configuration applies to hardware components of the apparatus; the configuration applies to software components of the apparatus.

In another embodiment, a method comprises: determining a performance associated with an application; executing a configuration associated with the application in order to substantially maintain the performance while reducing an energy consumption associated with the application; measuring a measured performance resulting from the executing; and adjusting the configuration in response to the measured performance. In some embodiments, the executing comprises instructing a configurable component to implement the configuration; the configurable component is a processor, and wherein the executing further comprises instructing the processor to operate at variable frequencies; the configurable component is a bus, a memory, a GPU, a receiver, or a transmitter; the executing comprises instructing a plurality of configurable components to implement the configuration.

In yet another embodiment, an apparatus comprises: a non-transitory memory comprising an application; a GUI configured to: display a first selector for a user to choose a target performance of the application; and receive a first user input indicating the target performance; and a controller coupled to the memory and to the GUI and configured to execute the target performance in response to the first user input. In some embodiments, the GUI is further configured to: display a second selector for the user to choose a target power consumption; and receive a second user input indicating the target power consumption, wherein the controller is further configured to: associate the target performance with the target power consumption; and execute the target performance in response to the associating; the GUI is further configured to: display a second selector for the user to choose whether the application is critical or non-critical; and receive a second user input indicating either critical or non-critical; the controller is further configured to: execute a default performance of the application when the second user input indicates that the application is critical, wherein the default performance is a performance of the application set by a developer of the application, a manufacturer of the apparatus, or the user; and execute the target performance when the application is not critical; wherein the controller is further configured to execute the target performance while the application is running.

In yet another embodiment, a computer program product comprises computer executable instructions stored on a non-transitory medium that when executed by a processor cause an apparatus to: adjust a configuration associated with an application in the apparatus independently of other applications in the apparatus; measure a measured performance corresponding to the configuration; and measure a measured power consumption corresponding to the configuration. In some embodiments, the instructions further cause the apparatus to adjust the configuration while the application is running; the instructions further cause the apparatus to: determine a performance associated with the application; and adjust the configuration in order to substantially maintain the performance while reducing an energy consumption associated with the application; the instructions further cause the apparatus to: display a selector for a user to choose a target performance associated with the application; receive a user input indicating the target performance; and execute the target performance in response to the user input; the instructions further cause the apparatus to: execute a default performance of the application when the application is critical; and execute a target performance of the application when the application is not critical.

Any of the above embodiments may be combined with any of the other above embodiments to create a new embodiment. These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of a device according to an embodiment of the disclosure.

FIG. 2 is a diagram of a profile table in FIG. 1.

FIG. 3 is a schematic diagram of a device according to an embodiment of the disclosure.

FIG. 4 is a flowchart of a method of energy optimization according to an embodiment of the disclosure.

FIG. 5 is a flowchart of a method of application profiling according to an embodiment of the disclosure.

FIG. 6 is a flowchart of a method of energy optimization according to another embodiment of the disclosure.

FIG. 7 is a table demonstrating experimental energy savings resulting from the method in FIG. 4.

FIG. 8 is a flowchart illustrating a method of energy optimization according to yet another embodiment of the disclosure.

### DETAILED DESCRIPTION

It should be understood at the outset that, although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

The following acronyms and initialisms apply:

ASIC: application specific integrated circuit

CPU: central processing unit

DSP: digital signal processor

DVFS: dynamic voltage and frequency scaling

EO: electrical-to-optical

FPGA: field-programmable gate array

Gb/s: gigabits per second

GHz: gigahertz

GPU: graphics processing unit

GUI: graphical user interface

MHz: megahertz

OE: optical-to-electrical

OS: operating system

PMU: performance monitoring unit

RAM: random-access memory

ROM: read-only memory

RX: receiver unit

s: seconds

SRAM: static RAM

TCAM: ternary content-addressable memory

TX: transmitter unit

W: watts

%: percent.

Smart device manufacturers may perform electrical power management through a variety of techniques. One such technique uses kernel modules known as governors to adjust smart device components at the circuit level using DVFS. The governors adjust processor frequencies or adjust other components and those components' functions based on system loads. Governors and other techniques perform electrical power management based on the fact that power is proportional to voltage and frequency. Thus, a decrease in voltage, frequency, or both decreases power. However, governors and other techniques are based on full system loads and therefore adjust entire systems independently of applications. In other words, those techniques are application agnostic. For that reason, those techniques do not provide optimal power management.

Disclosed herein are embodiments for application-specific, performance-aware energy optimization. A controller executes configurations in an application-specific manner. In other words, the controller executes the configurations for an application independently of other applications. In this context, independently may mean that the controller executes the configurations while the application is running and regardless of whether or not other applications are running. The controller executes the configurations in a performance-aware manner. For instance, the controller may distinguish between critical applications and non-critical applications, maintain or substantially maintain default performances for critical applications, and maintain or substantially maintain performances for non-critical applications. The embodiments substantially maintain performances of the applications while reducing energy consumptions of the applications. Energy is equal to power multiplied by time, so reducing power consumptions reduces energy consumptions when a time duration is fixed. Reducing the energy consumptions extends a battery life.

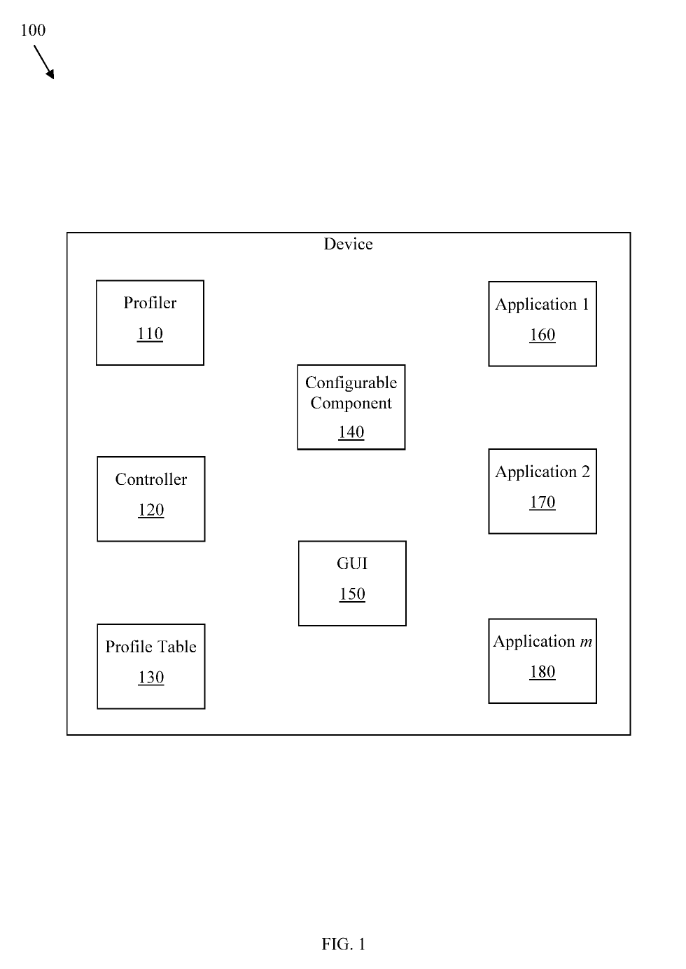

FIG. 1 is a schematic diagram of a device 100 according to an embodiment of the disclosure. The device 100 may be a smart device such as a mobile phone, a laptop computer, or a tablet computer. The device 100 comprises a profiler 110, a controller 120, a profile table 130, a configurable component 140, a GUI 150, and m applications 160-180, where m is a positive integer. The components of the device 100 are coupled to each other. The device 100 may be configured to communicate with other devices via a network such as a cellular network or the Internet.

The profiler 110 profiles the applications 160-180 to determine performances and power consumptions of the applications 160-180 for various configurations. The profiler 110 may do so in an offline manner or an online manner. Online means while the controller 120 is controlling a specified application 160-180, and offline means that the controller 120 is not controlling the specified application 160-180. The profiler 110 stores the configurations, the performances, and the power consumptions in the profile table 130.

The configurations, the performances, and the power consumptions make up characteristics of the applications 160-180. The configurations refer to an assignment of resources for the device 100 and associated with the applications 160-180. For instance, the configurations refer to any combination of a processor frequency, a bus bandwidth, a memory bandwidth, a thread migration, a GPU frequency, a network packet rate, or another metric. The configurations apply to hardware components, software components, or both hardware components and software components. The performances refer to a number of instructions the applications 160-180 execute in a period of time or refer to another metric. The power consumptions refer to an amount of power the applications 160-180 consume per an optimization period or refer to another metric. The optimization period may also be referred to as an optimization cycle, control period, or control cycle.

The controller 120 may also be referred to as an optimizer. The controller 120 maintains or substantially maintains default characteristics for critical applications 160-180, and the controller 120 maintains or substantially maintains target characteristics for non-critical applications in a manner that decreases or optimizes energy consumptions. A developer of the applications 160-180 may specify the default characteristics when developing the applications 160-180 or at another suitable time, and a manufacturer of the device 100 and a user of the device 100 may specify the default characteristics when installing the applications 160-180 or at another suitable time. The user may determine which target performances he or she desires for each application 160-180, and the controller 120 instructs the other components of the device 100 to execute target configurations associated with those target performances. The developer, the manufacturer, or the user designates which applications 160-180 are critical and which applications 160-180 are non-critical, and the developer, the manufacturer, and the user may change those designations at any time. Critical applications may be the applications 160-180 whose performances may not be sacrificed. Non-critical applications may be all other applications 160-180. The controller 120 may control the applications 160-180 while the applications 160-180 are running. The controller 120 may instruct the profiler 130 to profile the applications 160-180 in an offline manner, and the controller 120 may control the applications 160-180 in an online manner.

To execute a configuration, the controller 120 instructs the configurable component 140 to operate in a manner relative to the applications 160-180. For instance, if the configurable component 140 is a processor and the controller 120 is controlling the application 160, then the controller 120 instructs the processor to operate at a target frequency for all components of the device 100 while the application 160 is running and to operate at a default frequency for all components of the device 100 after the application 160 terminates. Alternatively, the controller 120 instructs the configurable component 140 to operate in a manner specific to each of the applications 160-180. Alternatively, the controller 120 instructs the applications 160-180 to operate in specific manners with the configurable component 140. The controller 120 may execute performances and power consumptions in similar manners.

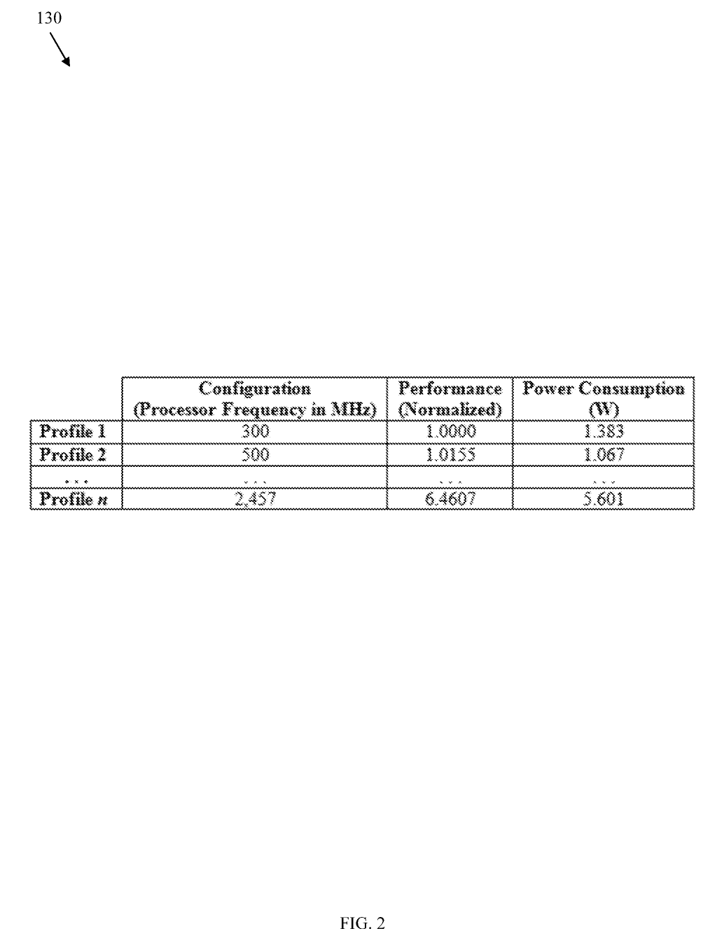

FIG. 2 is a diagram of the profile table 130 in FIG. 1. The profile table 130 comprises n profiles associated with one of the applications 160-180, for instance the application 160, where n is a positive integer. The device 100 comprises similar profile tables for the applications 170-180. Each profile comprises a configuration, a performance, and a power consumption.

As an example, profile 1 comprises a configuration of 300 MHz, a performance of 1.0000, and a power consumption of 1.383 W. The configuration of 300 MHz indicates that the application 160 uses the configurable component 140, for instance a processor, at a frequency of 300 MHz. Alternatively, the configuration of 300 MHz indicates that the processor 140 operates at a frequency of 300 MHz for all of the applications 160-180 for a period of time. The performance of 1.0000 is a normalized value that indicates that profile 1 has the lowest performance. In other words, the controller 120 collects all of the profiles, sorts the profiles from a first profile with a lowest performance to a last profile with a highest performance, designates the performance of the first profile as 1.0000, and designates the performances of the remaining profiles as multiples of the performance of the first profile. For instance, if profile 1 comprises a performance of 1,000 instructions/s, then profile 2 comprises a performance of 1,015.5 instructions/s and profile n comprises a performance of 6,460.7 instructions/s. Alternatively, the performances are un-normalized values. The power consumption of 1.383 W indicates that the application 160 consumes 1.383 W for a period of time.

Returning to FIG. 1, the configurable component 140 is any combination of a processor or a plurality of processors, a bus, a memory, a GPU, a receiver, a transmitter, or another component whose configuration the controller 120 may modify. For instance, the controller 120 may modify a processing speed of the processor or the GPU, a bandwidth of the bus or the memory, a thread migration among the processors, or a network packet rate of the receiver or the transmitter relative to the applications 160-180. Though one configurable component 140 is shown, the device 100 may have any number of configurable components and the controller 120 may simultaneously control any number of configurable components.

The GUI 150 presents a user interface to the user. The GUI 150 may provide a selector to prompt the user to designate which applications 160-180 are critical and which applications 160-180 are non-critical. The GUI 150 may also prompt the user to designate which target performances to apply to the applications 160-180. The applications 160-180 are communications applications, social media applications, entertainment applications, or other applications.

Though the components of the device 100 are shown as discrete components, the device 100 may combine or separate their functions in any suitable manner. As a first example, the profiler 110 and the controller 120 are a single component. As a second example, the profiler 110 and the controller 120 are in the device 100, and the controller 120 controls the applications 160-180 in a second device. As a third example, the device 100 is, or the components of the device 100 are, a component of a larger device or a logical partition of a larger device.

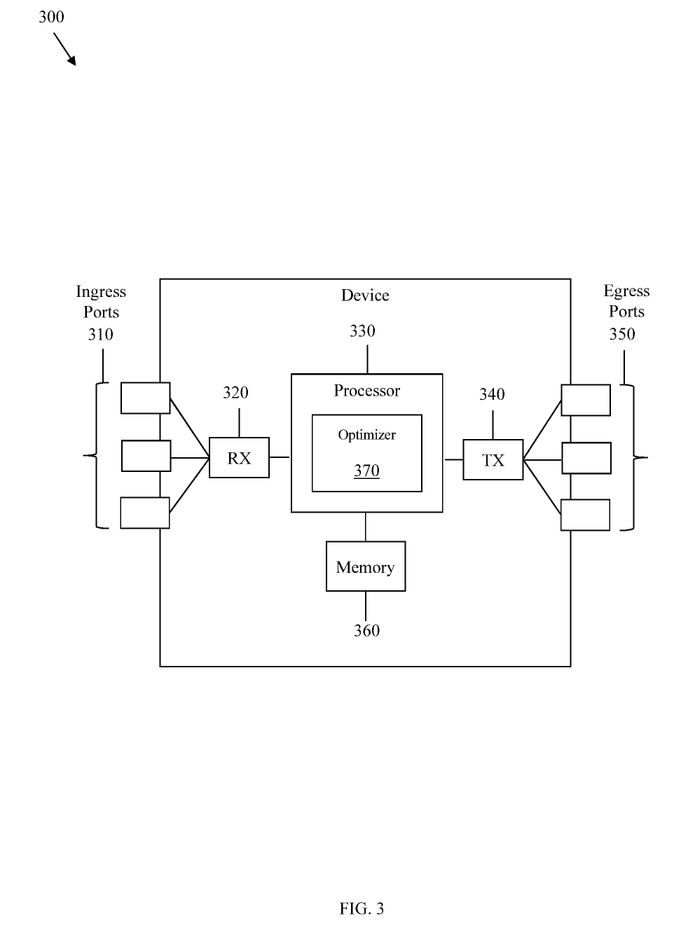

FIG. 3 is a schematic diagram of a device 300 according to an embodiment of the disclosure. The device 300 is suitable for implementing the device 100. The device 300 comprises ingress ports 310 and an RX 320 for receiving data; a processor, logic unit, or CPU 330 to process the data; a TX 340 and egress ports 350 for transmitting the data; and a memory 360 for storing the data. The device 300 may also comprise OE components and EO components coupled to the ingress ports 310, the RX 320, the TX 340, and the egress ports 350 for ingress or egress of optical or electrical signals.

The processor 330 is any suitable combination of hardware, middleware, firmware, and software. The processor 330 comprises any combination of one or more CPU chips, cores, FPGAs, ASICs, or DSPs. The processor 330 communicates with the ingress ports 310, RX 320, TX 340, egress ports 350, and/or memory 360. The processor 330 comprises an optimizer 370, which implements the disclosed embodiments. The inclusion of the optimizer 370 therefore provides a substantial improvement to the functionality of the device 300 and effects a transformation of the device 300 to a different state. Alternatively, the memory 360 stores the optimizer 370 as instructions, and the processor 330 executes those instructions.

The memory 360 comprises one or more disks, tape drives, and solid-state drives. The device 300 may use the memory 360 as an over-flow data storage device to store programs when the device 300 selects those programs for execution and to store instructions and data that the device 300 reads during execution of those programs. The memory 360 may be volatile or non-volatile and may be any combination of ROM, RAM, TCAM, or SRAM.

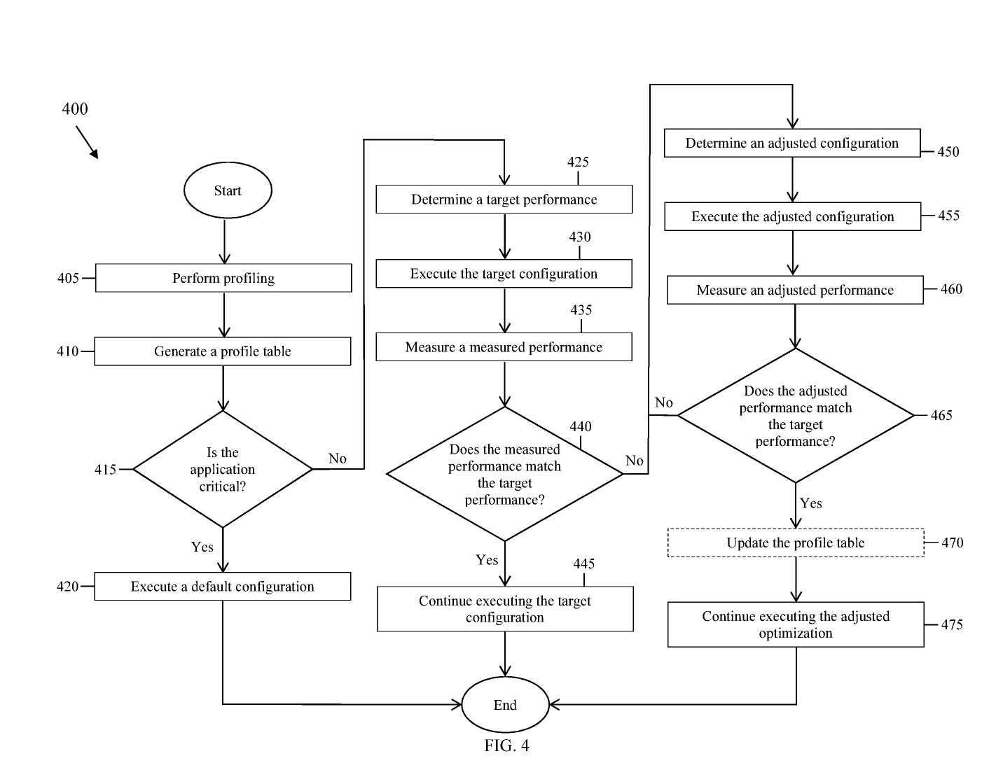

FIG. 4 is a flowchart of a method 400 of energy optimization according to an embodiment of the disclosure. The device 100 implements the method 400 when the user installs the applications 160-180, or at other suitable times. At step 405, the profiler 110 and the controller 120 perform profiling. The controller 120 instructs the profiler 110 to measure the offline performance and the offline power consumption of, for instance, the application 160 for different configurations. At step 410, the profiler 110 generates the profile table 130 from those configurations, performances, and power consumptions.

At decision diamond 415, the controller 120 determines whether the application 160 is critical. For instance, the GUI 150 prompts the user to indicate whether the application 160 is critical. If the application 160 is critical, then the method 400 proceeds to step 420. At step 420, the controller 120 executes a default configuration, such as until the application 160 terminates. The profiler 110 obtains the default configuration from the developer, the manufacturer, or the user and indicates the default configuration in the profile table 130. The controller 120 then determines the default configuration from the profile table 130 and executes the default configuration. For instance, the default configuration is 2,457 MHz, or 2.457 GHz, in the profile table 130. The controller 120 instructs the configurable component 140, in this case a processor, to process at the frequency of 2.457 GHz while the application 160 is running. If the application 160 is non-critical, then the method proceeds to step 425.

At step 425, the controller 120 determines a target performance. For instance, the GUI 150 prompts the user for the target performance and displays a selector for that purpose. For instance, using the profile table 130, the GUI 150 displays a sliding scale for target performances and a corresponding sliding scale for target power consumptions. The sliding scale for target performances may indicate slow, medium, fast, or other similar words, and the sliding scale for target power consumptions may indicate standard, improved, accelerated, or other similar words. Instead of using words, the sliding scales may indicate the values from the profile table 130 or other suitable values, which may be easier for the user to understand. The user provides a user input to the sliding scales. As the sliding scale for target performances moves in response to the user input, for instance as the sliding scale for target performances moves from fast to slow, the sliding scale for target power consumptions moves in a corresponding manner, for instance from standard to accelerated. The GUI 150 determines a target performance from the user input and transmits the target performance to the controller 120. For instance, the GUI 150 transmits to the controller 120 the target performance of 1.0155 from the profile table 130. Alternatively, the user provides a user input for a target power consumption or both the target performance and the target power consumption.

At step 430, the controller 120 executes the target configuration. The controller 120 references the profile table 130 and determines the target configuration of 500 MHz corresponding to the target performance of 1.0155. The controller 120 executes the target configuration. For instance, the controller 120 instructs the configurable component 140 to operate at a frequency of 500 MHz.

At step 435, the profiler 110 measures a measured performance of the application 160. For instance, the profiler 110 measures a measured performance of 1.0100. The profiler 110 transmits the measured performance to the controller 120.

At decision diamond 440, the controller 120 determines whether the measured performance matches the target performance. The controller 120 may do so within a performance margin of, for instance, 0.5%. If the measured performance matches the target performance, then the method 400 proceeds to step 445. At step 445, the controller 120 continues executing the target configuration until the application 160 terminates. If the measured performance does not match the target performance, then the method proceeds to step 450. For instance, the measured performance of 1.0100 is about 0.54% less than the specified performance of 1.0155, and 0.54% is greater than the performance margin of 0.5%. That discrepancy may occur due to the concurrent operation of the applications 170-180, an age of the device 100, an ambient temperature, or other factors that may change between a profiling of the application 160 and the execution of the target configuration.

At step 450, the controller 120 determines an adjusted configuration. The controller 120 may determine the adjusted configuration using a proportional calculation, a regression analysis calculation, or another calculation relative to the target configuration, the target performance, and the target power consumption. For instance, the controller 120 determines an adjusted configuration of 503 MHz. Alternatively, the adjusted configuration is an increment of the target configuration. For instance, the adjusted configuration is 503 MHz-500 MHz, or 3 MHz. At step 455, the controller 120 executes the adjusted configuration. For instance, the controller 120 instructs the configurable component 140 to operate at a frequency of 503 MHz.

At step 460, the profiler 110 measures an adjusted performance of the application 160. For instance, the profiler 110 measures an adjusted performance of 1.0101. The profiler 110 transmits the adjusted performance to the controller 120.

At decision diamond 465, the controller 120 determines whether the adjusted performance matches the target performance. The controller 120 may do so within a performance margin of, for instance, 0.5%. If the adjusted performance matches the target performance, then the method 400 proceeds to step 470. For instance, the adjusted performance of 1.0150 is about 0.05% less than the target performance of 1.0155, and 0.05% is less than the performance margin of 0.5%. If the measured performance does not match the target performance, then the method returns to step 450. For instance, the measured performance is 1.0101.

Optionally, at step 470, the controller 120 updates the profile table 130. The controller 120 updates the profile table 130 so that the profile table 130 matches the measured performance. For instance, for profile 2, the controller 120 changes the configuration from 500 MHz to 503 MHz. Finally, at step 475, the controller 120 continues executing the adjusted optimization until the application 160 terminates.

The controller 120 may control the application 160 while the application 160 is running. The controller 120 may do so for a next available optimization period. For instance, if optimization periods are 2 s, the profiler 110 measures a measured performance from 0 s to 1 s, and the profiler 110 reports the measured performance to the controller 120 at 1.5 s, then the controller 120 controls the application 160 from 2 s to 4 s using the measured performance.

The controller 120 prompts the profiler 110 for the measured performance, and the profiler 110 provides the measured performance to the controller 120 in response. Alternatively, the profiler 110 provides the measured performance to the controller 120 in response to another event. The profiler 110 may obtain the measured performance directly from the applications 160-180 or from another component such as a PMU, which may be a separate component or may be part of the configurable component 140 or another component.

The controller 120 may instruct the configurable component 140 to operate at variable frequencies in order to reduce energy consumption while substantially meeting performances. Substantially may mean within 1%, 5%, 10%, or another suitable metric. For instance, at step 425, the GUI 150 determines the target performance of 1.0155 from the user input and transmits the target performance to the controller 120. For the first 0.8 s of the next optimization period, the controller 120 instructs the configurable component 140 to operate at a frequency of 525 MHz, which is 25 MHz greater than the target configuration of 500 MHz corresponding to the target performance of 1.0155 in the profile table 130. For the remaining 1.2 s of the next optimization period, the controller 120 instructs the configurable component 140 to operate at a frequency of 480 MHz, which is 20 MHz less than the target configuration of 500 MHz corresponding to the target performance of 1.0155 in the profile table 130. The average frequency during the next optimization period may therefore be about 500 MHz, the target configuration. The device 100 may use an iterative method similar to the method 400 to implement this variable-frequency approach. The controller 120 may be intelligent so that, over time, it improves the frequency variability in order to further reduce energy consumption while meeting performances.

The controller 120 may instruct configurations of the application 160 without the user input in some examples. Specifically, the controller 120 determines the default performance of the application 160 and instructs the configurable component 140 to operate at variable frequencies as described above. For instance, the default performance of 6.4607 corresponds to the default configuration of 2.457 GHz. For the first 0.8 s of the next optimization period, the controller 120 instructs the configurable component 140 to operate at a frequency of 2.6 GHz, which is 143 MHz greater than the default configuration of 2.457 MHz. For the remaining 1.2 s of the next optimization period, the controller 120 instructs the configurable component 140 to operate at a frequency of 2.3 GHz, which is 157 MHz less than the default configuration of 2.457 GHz. The variable frequencies of 2.6 GHz and 2.3 GHz make up an optimized configuration. The average frequency during the next optimization period may therefore be about 2.457 GHz, the target configuration.

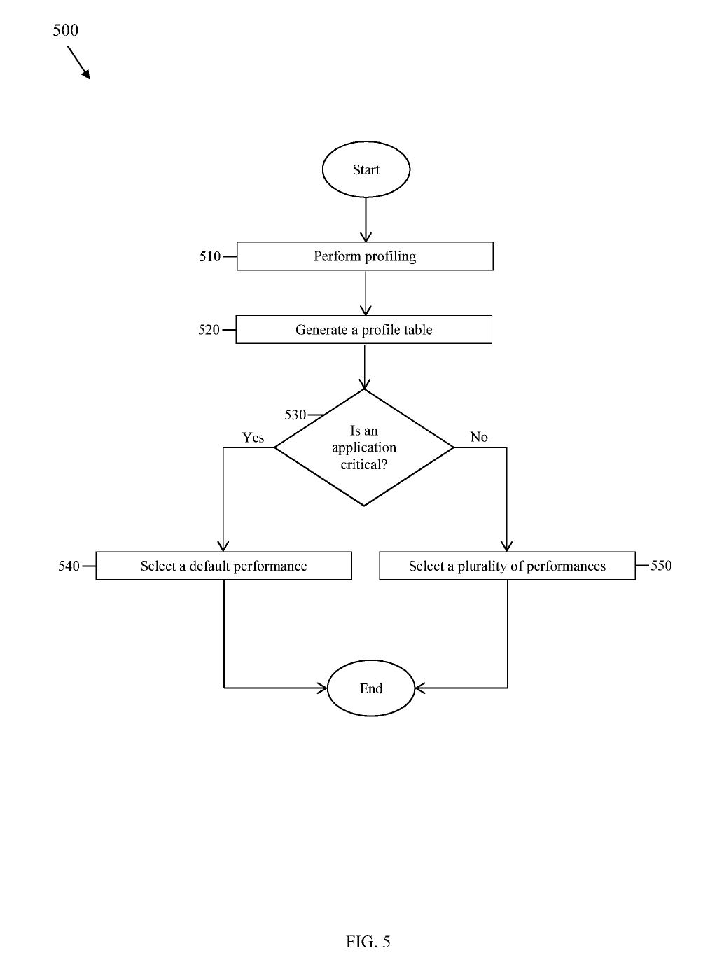

FIG. 5 is a flowchart of a method 500 of application profiling according to an embodiment of the disclosure. The device 100 implements the method 500 when the user installs one of the applications 160-180, for instance the application 160, or at other suitable times. The device 100 performs the method 500 in order to generate the profile table 130, which the controller 120 uses to implement energy optimization.

At step 510, the profiler 110 performs profiling. The profiler 110 may measure performances and power consumptions for various configurations. At step 520, the profiler 110 generates the profile table 130 from those configurations, performances, and power consumptions. The profiler 110 designates one of the configurations a default configuration, one of the performances a default performance, and one of the power consumptions a default power consumption.

At decision diamond 530, the developer, the manufacturer, or the user determines whether the application 160 is critical. If at decision diamond 530 the application is determined to be critical, then the method 500 proceeds to step 540. At step 540, the controller 120 selects a default performance of the application 160. The default performance of the application 160 may be a number chosen from the profile table 130. The controller 120 determines the default performance from the profile table 130 or from the developer, the manufacturer, or the user. If at decision diamond 530 the application is determined to be non-critical, then the method 500 proceeds to step 560. At step 560, the controller 120 selects a plurality of performances for further selection by the user.

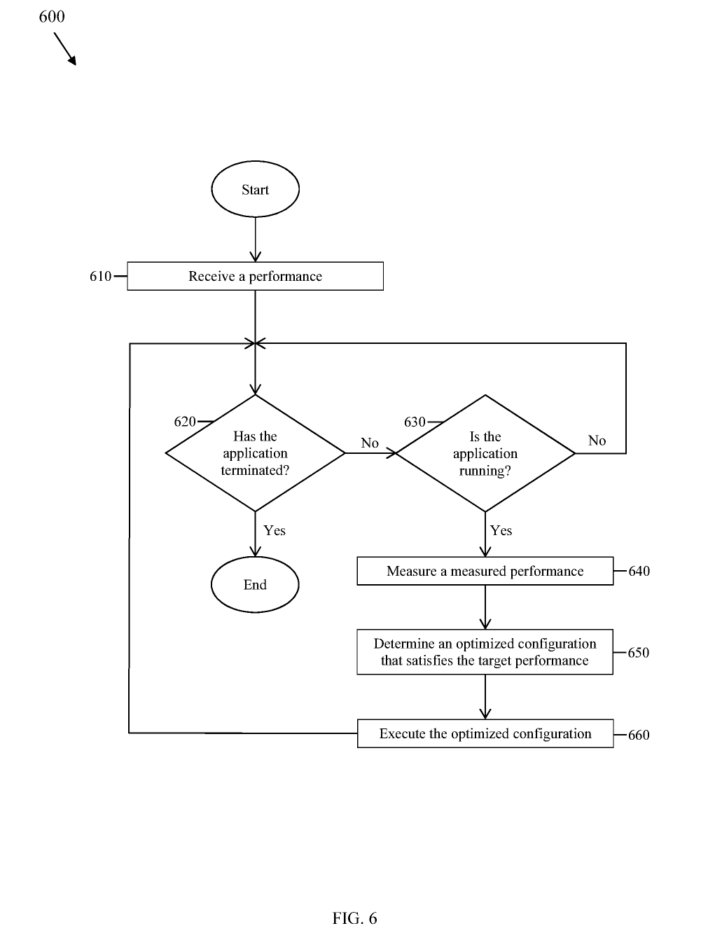

FIG. 6 is a flowchart of a method 600 of energy optimization according to another embodiment of the disclosure. The device 100 implements the method 600 and may do so after step 540 or step 550 in FIG. 5. At step 610, the controller 120 receives a performance. The performance is the default performance in step 540 when the application 160 is critical or is a target performance selected from among the plurality of performances in step 550 when the application 160 is non-critical.

At decision diamond 620, the controller 120 determines whether the application 160 has terminated. For instance, the user may terminate the application 160. If the application 160 has terminated, then the method 600 ends. If the application 160 has not terminated, then the method 600 proceeds to decision diamond 630.

At decision diamond 630, the controller 120 determines whether the application 160 is running. For instance, the controller 120 determines whether the user is actively using the application 160 or if the user has minimized the application 160. If the application 160 is not running, then the method 600 returns to decision diamond 620. If the application is running, then the method 600 proceeds to step 640.

At step 640, the profiler 110 measures a measured performance of the application 160. At step 650, the controller 120 determines an optimized configuration that satisfies the target performance. The controller 120 does so by referencing the profile table 130 and determining a configuration that satisfies the target performance, but also minimizes energy consumption. Finally, at step 660, the controller 120 executes the optimized configuration and returns to decision diamond 620. The device 100 may execute decision diamonds 620-630 and steps 640-660 periodically. The manufacturer may set the periodicity.

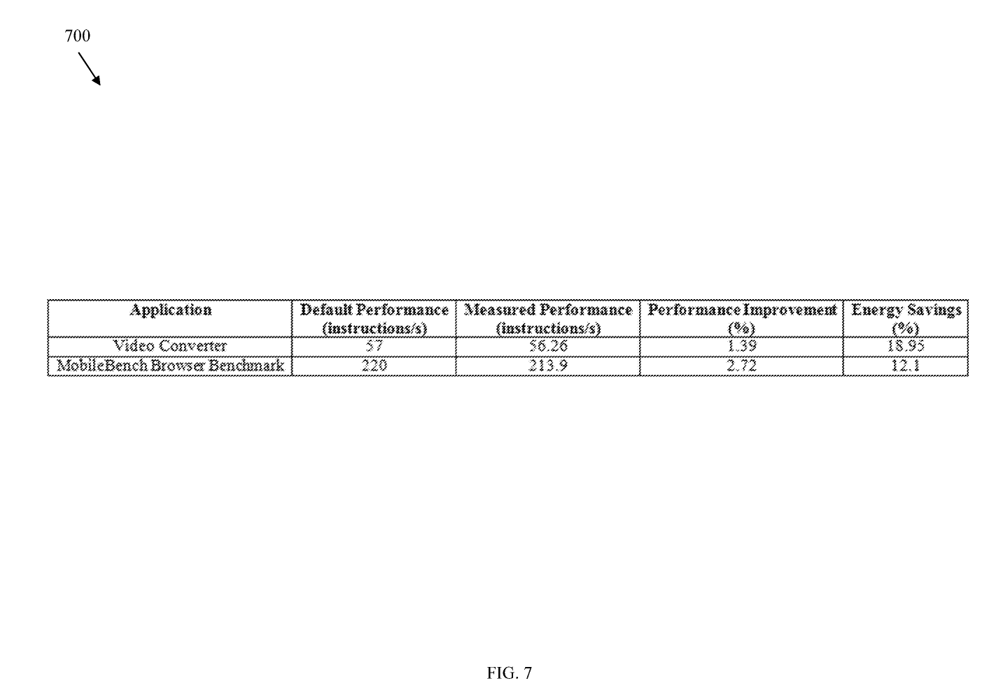

FIG. 7 is a table 700 demonstrating experimental energy savings resulting from the method 600 in FIG. 6. The experiment was conducted on a Google Nexus 6 mobile phone using the Android 6.0 OS and running the Linux kernel version 3.10. The table 700 shows target performances, measured performances, performance improvements, and energy savings for two applications, namely a video converter application and a MobileBench browser benchmark application.

For the video converter application, the method 600 provides an energy savings of 18.95% while maintaining approximately the same performance. For the MobileBench browser benchmark application, the method 600 provides an energy savings of 12.1% while maintaining approximately the same performance. In fact, for both scenarios, the measured performance was slightly higher than the target performance. Those energy savings improve battery life.

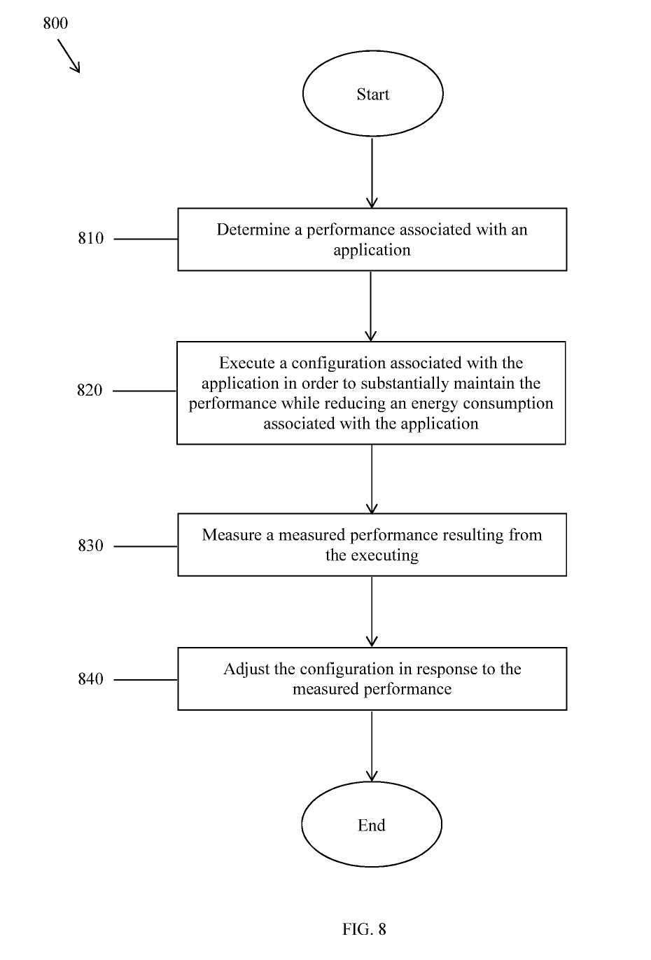

FIG. 8 is a flowchart illustrating a method 800 of energy optimization according to yet another embodiment of the disclosure. The device 100 implements the method 800 when the user installs the applications 160-180 or at other suitable times. At step 810, a performance associated with the application is determined. For instance, the performance is a target performance, which the profiler 110 determines without a user input. Alternatively, the GUI 150 receives a user input indicating a performance associated with the application 160.

At step 820, a configuration associated with the application is executed in order to substantially maintain the performance while reducing energy consumption associated with the application. For instance, the controller 120 executes the configuration, which comprises variable frequencies. Alternatively, the controller 120 references the profile table 130, determines the configuration corresponding to the performance, and executes the configuration.

At step 830, a measured performance resulting from the executing is measured. For instance, the profiler 110 measures the measured performance of the application 160 resulting from executing the application. Finally, at step 840, the configuration is adjusted in response to the measured performance. For instance, the controller 120 determines that the optimized performance does not match the optimized performance within a performance margin and determines an adjusted configuration.

In an example embodiment, an apparatus comprises: a non-transitory memory element comprising an application; a controller element coupled to the memory and configured to adjust a configuration associated with the application independently of other applications in the apparatus, wherein the configuration is an assignment of resources of the apparatus; and a profiler element coupled to the memory and configured to: measure a measured performance corresponding to the configuration; and measure a measured power consumption corresponding to the configuration.

While several embodiments have been provided in the present disclosure, it may be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, components, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and may be made without departing from the spirit and scope disclosed herein.

What is claimed is:

1. An apparatus comprising:
a non-transitory memory comprising an application;
a controller coupled to the memory and configured to adjust a configuration associated with the application independently of other applications in the apparatus, wherein the configuration is an assignment of resources of the apparatus; and
a profiler coupled to the memory and configured to:
measure a measured performance corresponding to the configuration; and
measure a measured power consumption corresponding to the configuration.

2. The apparatus of claim 1, wherein the configuration comprises one of a processor frequency associated with the application, a memory bandwidth associated with the application, a thread migration associated with the application, a graphics processing unit (GPU) frequency associated with the application, or a network packet rate associated with the application.

3. The apparatus of claim 2, wherein the configuration comprises at least two of a processor frequency associated with the application, a memory bandwidth associated with the application, a thread migration associated with the application, a GPU frequency associated with the application, or a network packet rate associated with the application.

4. The apparatus of claim 1, wherein the configuration applies to hardware components of the apparatus.

5. The apparatus of claim 1, wherein the configuration applies to software components of the apparatus.

6. A method comprising:
determining a performance associated with an application;
executing a configuration associated with the application in order to substantially maintain the performance while reducing an energy consumption associated with the application;
measuring a measured performance resulting from the executing; and
adjusting the configuration in response to the measured performance.

7. The method of claim 6, wherein the executing comprises instructing a configurable component to implement the configuration.

8. The method of claim 7, wherein the configurable component is a processor, and wherein the executing further comprises instructing the processor to operate at variable frequencies.

9. The method of claim 7, wherein the configurable component is a bus, a memory, a graphics processing unit (GPU), a receiver, or a transmitter.

10. The method of claim 6, wherein the executing comprises instructing a plurality of configurable components to implement the configuration.

11. An apparatus comprising:
a non-transitory memory comprising an application;
a graphical user interface (GUI) configured to:
display a first selector for a user to choose a target performance of the application; and
receive a first user input indicating the target performance; and
a controller coupled to the memory and to the GUI and configured to execute the target performance in response to the first user input.

12. The apparatus of claim 11, wherein the GUI is further configured to:
display a second selector for the user to choose a target power consumption; and
receive a second user input indicating the target power consumption, wherein the controller is further configured to:
associate the target performance with the target power consumption; and
execute the target performance in response to the associating.

13. The apparatus of claim 11, wherein the GUI is further configured to:
display a second selector for the user to choose whether the application is critical or non-critical; and
receive a second user input indicating either critical or non-critical.

14. The apparatus of claim 13, wherein the controller is further configured to:
execute a default performance of the application when the second user input indicates that the application is critical, wherein the default performance is a performance of the application set by a developer of the application, a manufacturer of the apparatus, or the user; and
execute the target performance when the application is not critical.

15. The apparatus of claim 11, wherein the controller is further configured to execute the target performance while the application is running.

16. A computer program product comprising computer executable instructions stored on a non-transitory medium that when executed by a processor cause an apparatus to:
adjust a configuration associated with an application in the apparatus independently of other applications in the apparatus;
measure a measured performance corresponding to the configuration; and
measure a measured power consumption corresponding to the configuration.

17. The computer program product of claim 16, wherein the instructions further cause the apparatus to adjust the configuration while the application is running.

18. The computer program product of claim 16, wherein the instructions further cause the apparatus to:
determine a performance associated with the application; and
adjust the configuration in order to substantially maintain the performance while reducing an energy consumption associated with the application.

19. The computer program product of claim 16, wherein the instructions further cause the apparatus to:
display a selector for a user to choose a target performance associated with the application;
receive a user input indicating the target performance; and
execute the target performance in response to the user input.

20. The computer program product of claim 16, wherein the instructions further cause the apparatus to:
execute a default performance of the application when the application is critical; and
execute a target performance of the application when the application is not critical.
